(19) United States
(12) Patent Application Publication
(10) Pub. No.: US 2017/0132232 A1
(43) Pub. Date: May 11, 2017

(54) DATA LOAD FROM A DATA SOURCE INTO A TARGET FILE

(71) Applicant: HEWLETT PACKARD ENTERPRISE DEVELOPMENT LP, Houston, TX (US)

(72) Inventors: Larry N. ALLEN, Plano, TX (US); Justin J. SIMONDS, Ladera Ranch, CA (US)

(73) Assignee: HEWLETT PACKARD ENTERPRISE DEVELOPMENT LP, Houston, TX (US)

(21) Appl. No.: 15/306,323

(22) PCT Filed: Jul. 17, 2014
(86) PCT No.: PCT/US2014/047098

§ 371 Date: Oct. 24, 2016

(51) Int. Cl. G06F 17/30

(52) U.S. Cl. CPC G06F 17/30076; G06F 17/30371

(57) ABSTRACT

A data integration system and method facilitate data to be loaded into a target file. The data loaded into the target file is from one or more data sources. The data is loaded from a data source into the target file in accordance with the data format definition of the data source and the data format definition of the target file.

### BACKGROUND

With the advent of on-line systems and networks, large amounts of data exist to be processed and stored.

### BRIEF DESCRIPTION OF THE DRAWINGS

For a detailed description of various examples, reference will now be made to the accompanying drawings in which:

FIG. 1 shows an overview of a data integration system in accordance with an example;

FIG. 2 shows an implementation of a data integration system in accordance with an example;

FIG. 3 illustrates how data may be loaded from a data source into a target file in accordance with various examples;

FIG. 4 shows another implementation of a data integration system in accordance with an example;

FIG. 5 shows yet another implementation of a data integration system in accordance with an example;

FIG. 6 shows a method performed by a data integration system in accordance with an example; and

FIG. 7 shows another method performed by a data integration system in accordance with an example.

### DETAILED DESCRIPTION

In some cases involving large amounts of data, the data is in one pre-designated format which makes its processing relatively straightforward. In other cases, however, the data is available but only in disparate formats. In these latter cases, the data may originate from different sources but contain much the same type of information. One data source may provide its data in an Extensible Markup Language (XML) format, while another source of similar data may provide its data in a Comma-Separated Value (CSV) format. Further, the data from each source may contain numerous records, with each record including similar fields of information but the data fields are in different orders among the various data sources. For example, a “name” field may be the first field in the records from one data source, but the third field in the records from a different data source.

The structural disparity of such data from various data sources makes the processing of such data in a cohesive, federated manner difficult. The implementations described herein address this issue. In general, the disclosed implementations describe a data integration system through which a user can separately define the structure of the data from each data source so that the differently structured data from the various data sources can be loaded into one centralized consolidated database of one pre-defined structure for further processing.

The term “structure” in this context defines the order of data fields in the records from a particular data source as well as the format of the fields. For example, a date field may be defined in a variety of formats including MM/DD/YY (two digits for each of month, day, and year separated by a forward slash), YYYY-MM-DD (four digits for year, followed by two digits for each of the month and day, hyphen separated), etc. The structure of the data refers to such formatting of individual fields of data as well.

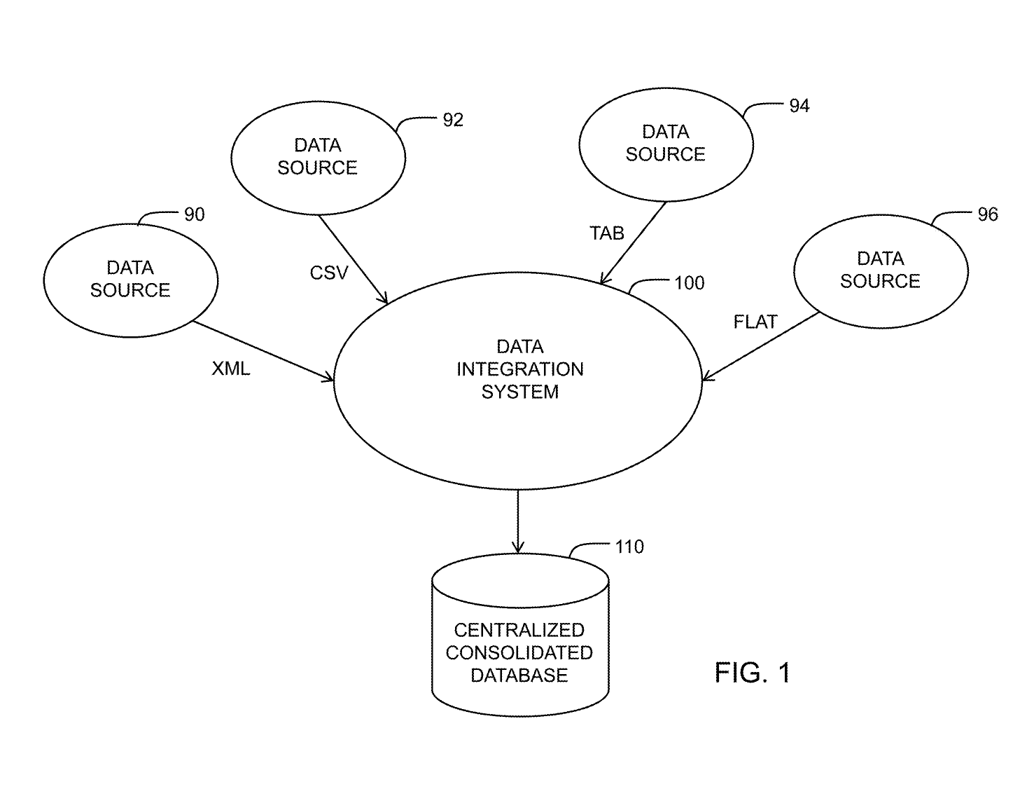

FIG. 1 illustrates a data integration system 100 which provides data from various data sources 90, 92, 94, and 96 into a single consolidated database 110. The data itself can of any type. In one example, the data from the various data sources 90-96 includes health claim-related data (e.g., Medicare data) and the individual data sources are systems and/or databases from individual states (Texas, Montana, etc.). Each such state may maintain its health claim-related data in its own manner. The data from data source 90 may include XML data. The data from data source 92 may include CSV data. The data from data source 94 may include tab delimited (TAB) data, while the data from data source 96 may include a flat file.

The data integration system 100 permits a user to independently specify the structure of the data originating from each data source. The user may specify, for each record from a given data source, the type and order of the fields of the records as well as any format-specific information about an individual field (see date example provided above). The user may also define the structure of centralized consolidated database 110. The data integration system 100 receives the data from each data source and loads each such source's data into the centralized consolidated database 110 based on the structure of the incoming data from the source and the structure of the centralized consolidated database. The loading of the data by the data integration system 100 may include changing the order of the fields of each record in the incoming data to match the structure of the centralized consolidated database. The loading of the data also may include converting at least some of the data (e.g., converting a date field from one format to another). By permitting a user to specify how data is to be organized in a target file and permitting the user to specify how data is organized from a data source, the data integration system is able to bring all such sources of data into one centralized consolidated database and thus in a common format thereby facilitating processing of the data.

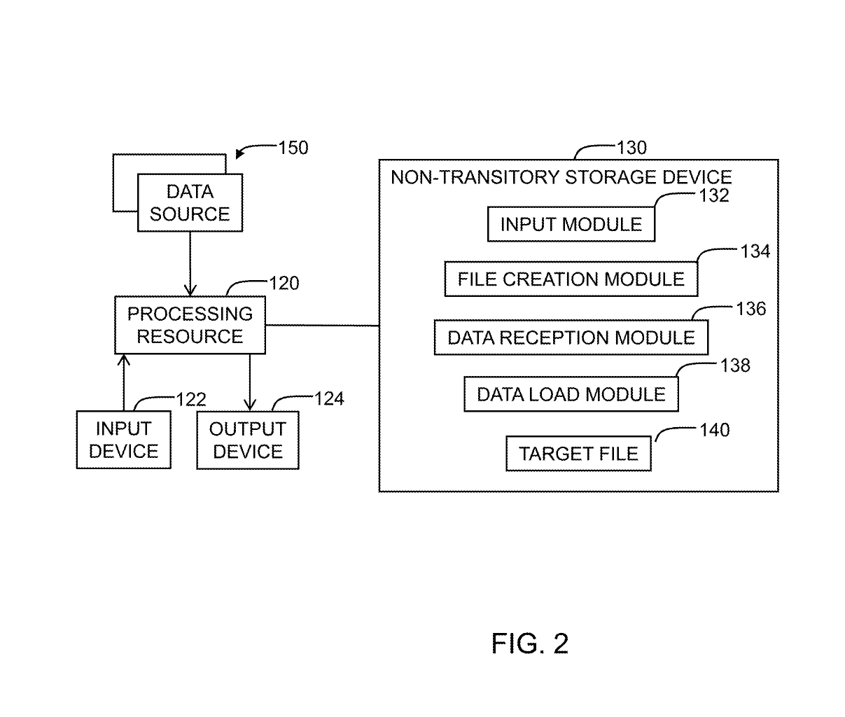

FIG. 2 illustrates an example of an implementation of the data integration system. The system of the example of FIG. 2 includes a processing resource 120 coupled to a non-transitory storage device 130. An input device 122 (e.g., keyboard, mouse, etc.) and an output device 124 (e.g., display) are also included and coupled to the processing resource. The data integration system may be implemented as a computer.

The processing resource is a hardware element that executes machine instructions. The processing resource 120 may include a single processor, multiple processors, a single computer, or a network of computers. The non-transitory storage device 130 is volatile storage (e.g., random access memory), non-volatile storage (e.g., magnetic storage device such as a hard drive, optical storage, solid state storage, etc.), or combinations thereof.

The non-transitory storage device 130 includes various executable software modules such as modules 132-138. Each software module 132-138 includes machine instructions that are executable by processing resource 120 to implement some or all of the functionality described herein. The non-transitory storage device 130 also includes a target file 140 into which the data from various data sources 150 is stored. The explanation below as to functions performed by each module is attributed to the processing resource 120 executing that particular module. Separate software modules may be provided as shown, or the functionality of two or more or all of the modules may be provided in one set of machine instructions.

The input module 132 is usable to receive input (e.g., from a user) to specify a target file data format definition to define how data is to be organized in target file 140. For example, the user may desire to create a target file called “inv_transactions” to include a plurality of records. Each record may include, and in this order, a transaction identifier, an item identifier, an employee identifier, a transaction type, a quantity value, a creation date, a shipment date, and notes. Each of these fields may have field-specific characteristics such as whether the field is a character field, a numeric field, the size of the field, etc. The following is a corresponding example:

>> Create table inv_transactions
( inv_transact_id numeric
item_id char(10)
employee_id varchar(20)
transaction_type char(10)
quantity numeric(6)
transaction_created timestamp(0)
transaction_shipped timestamp(0)
notes varchar(200)
)
;

The numbers in parentheses are sizes of the various fields. The input module permits the specification of the names of the individual fields (e.g., inv_transact_id, item_id, etc.), the field types (e.g., numeric, char, varchar, timestamp, etc.), and the size of each field. In some implementations, the user may specify such information via the input device 122 on a graphical user interface (GUI) displayed by the processing resource 120 on the output device 124. Via the input module 132, the user is able to generate a data format definition to define how data is to be organized in the target file.

The file creation module 134 is usable to create target file 140 in accordance with the target file data format definition. The target file 140 can be implemented, for example, as a Structured Query Language/MX (SQL/MX) table having the structure defined by the target file data format definition.

The data reception module 136 receives a data source data format definition of data from a data source (e.g., data sources 150). The data source data format definition is similar to the target file data format definition, but is applicable to the data source itself. That is, the data source data format definition also may specify which fields are included (and their order) in each record from a given data source 150, the type of each field (char, numeric, etc.), and the size of each such field.

The following is example of a data source data format definition:

[DATE FORMAT]
DateOrder=YMD
DateDelimiter=-
TimeDelimiter=:
FourDigitYear=N
DecimalSymbol=.
NormalizeDate=Y
[COLUMN FORMAT]
Col=inv_transact_id, N
Col=item_id, N
Col=employee_id, N
Col=transaction_type, N
Col=quantity, N
Col=transaction_created, N
Col=transaction_shipped, N
Col=notes, N
[DELIMITED FORMAT]
FieldDelimiter=,
RowDelimiter=\n

The date format is in the order of ‘YMD’ with each field separated by a hyphen delimiter. The year is not a four digit field (meaning it is a 2 digit field). Each record has the data fields: inv_transact_id, item_id, employee_id, transaction_type, quantity, transaction_created (a date), transaction_shipped (a date), and notes. Each of these fields are delimited by a comma (,) and the end of each row is delimited by “\”.

The data source structure specified by the data source data format definition may be the same as or different from the target file data format. Further, the data source data format definition for a given data source may differ from the data source data format definition for a different data source. Some or all of the data sources may have different data source data format definitions to accommodate a potentially wide disparity of structure of the incoming data from the various data sources. Further, two or more of the data sources may include data in the same format and thus can use or share the same data format definition.

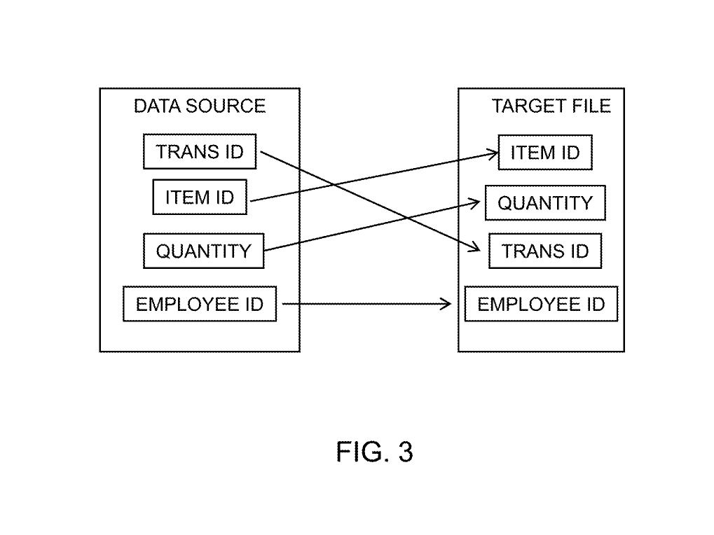

The data load module 138 causes data to be loaded from each data source 150 into the target file 140 in accordance with the data source data format definition for that particular data source 150 and the target file data format definition for the target file 140. The loading of the data may include copying data from fields of the data source data to corresponding fields in the target file with the understanding that the fields may be in different orders between the data source and the target file. The order of the fields of the data source is specified by the data source data format definition and the order of the fields of the target file is specified by the target file data format definition. FIG. 3 provides an example of data from a data source containing four data fields: TRANS ID, ITEM ID, QUANTITY, and EMPLOYEE ID. The target file has the same data fields but in a different order. Thus, when the data source data is loaded into the target file, the data load module 138 examines the data format definitions of the data source and target file to determine the order in which the data is copied from the data source and into the target file, as indicated by the arrows in FIG. 3.

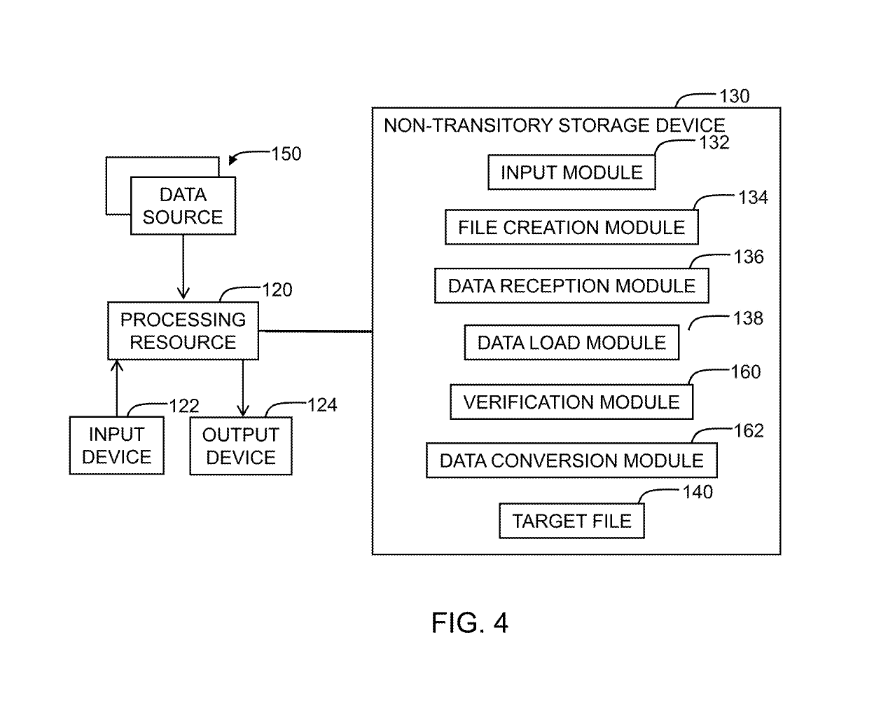

FIG. 4 illustrates another implementation of the data integration system. The implementation of FIG. 4 is similar in some respects to that of FIG. 2. The elements in FIG. 4 that are numbered the same as elements in FIG. 2 perform the same or similar functions. Accordingly, those functions are again described with respect to FIG. 4. The difference between the implementations of FIGS. 2 and 4 is the inclusion in FIG. 4 of additional software modules 160 and 162 that are not shown in FIG. 2. These software modules also include machine instructions that are executable by processing resource 120 to perform the functionality described herein.

The verification module 160 verifies the integrity of the data from each data source before such data is loaded into the target file. The integrity verification for data from a particular data source is performed based on the data source data format definition for that particular data source. As explained above, the data source data format definition defines the structure of the data from a given data source. The structure so specified includes the number of fields of information in each record, the size of each field, formatting information for a particular field, etc. For example, the data source data format definition may specify that the sixth and seventh fields of information in each record include dates of a particular date format. The definition may also specify how each of the fields are separated from each other (e.g., which delimiter is used—comma, tab, etc.). The verification module 160 performs an integrity verification that includes at least one of:
a verification that proper delimiters are used in the data from the first data source (e.g., verification that columns within the data source's data are separated by the proper delimiter, verification that extra delimiters have not been added to any row, etc.);
verification of the format of a date from the first data source (e.g., verification that dates are in the correct format and can be directly imported into a data field in the target file); and
a verification that the number of fields in each record of the data from the first data source is consistent

An example of the second listed verification above may include a verification as to whether a date from the data source 150 can be directly imported into a data field in the target file 140. A direct import of a date is possible if the data source data format definition for the data source defines a date to have the same format (e.g., YYYY-MM-DD) as the corresponding date field defined by the target file data format definition. If a date from the data source 150 is in a different date format than that required by the target file 140 (e.g., source data is in the YYYY-MM-DD format but target file expects the date to be in the MM/DD/YY format), the date is converted before it is loaded into the target file. This conversion is performed by the data conversion module 162. Generally, the data conversion module 162 causes the processing resource 120 to convert data from the data source based on the data source data format definition and the target file data format definition. The data conversion module 162 may convert data fields other than dates. The data conversion module 162 may append or prepend data from the data source with fixed characters (e.g., 0's), and perform other types of conversions as well.

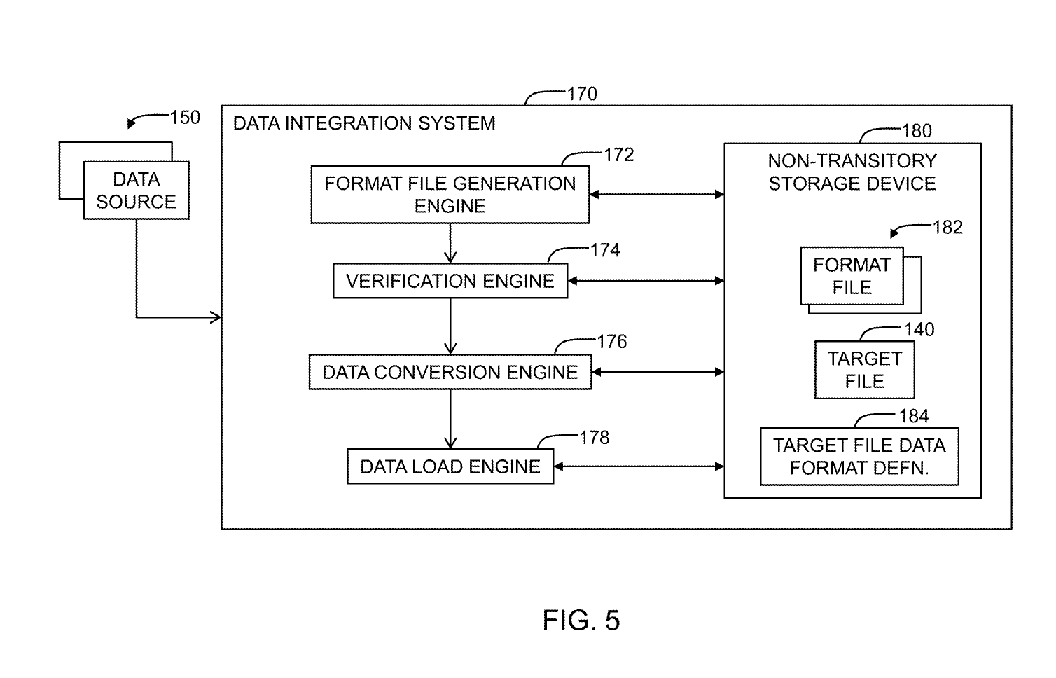

FIG. 5 illustrates another implementation of a data integration system 170 that receives data from various data sources 150 as explained above. The data integration system of the example of FIG. 5 includes format file generation engine 12, a verification engine 174, a data conversion engine 176, and a data load engine 178, although additional engines may be provided as well. Each engine is implemented as a processing resource (e.g., processing resource 120) executing a software module (e.g., the modules illustrated in FIGS. 2 and 4). For example, the verification engine 174 is implemented as processing resource 120 executing the verification module 160, while the data conversion and data load engines 176 and 180 are implemented as the processing resource 120 executing the data conversion module 162 and data load module 138, respectively.

The non-transitory storage device 180 (volatile and/or non-volatile storage as explained above) includes one or more format files 182 in addition to the target file 140. The target file data format definition 184 may be created by the user input module 132 as noted above and is also stored on the non-transitory storage device 180. Each format file 182 is associated with a particular data source 150 and contains the data source data format definition for that particular data source. The format file generation engine 172 creates, for each data source 150, a format file 182 that includes a data source data format definition specifying a structure of data from each such data source.

The verification engine 174 verifies that the data from each data source 150 is consistent with the data format definition included in the format file for each such data source. Examples of data verification are provided above.

The data conversion engine 176 converts at least some data from at least one data source from one format to another format. An example of data conversion includes date format conversion, appending or prepending fixed characters to a data field, etc.

The data load engine loads data from each data source, after verification and data conversion, to the target file 140 based on, as explained above, the data source data format definition from the format file 182 for each such data source 150 and a target file data format definition.

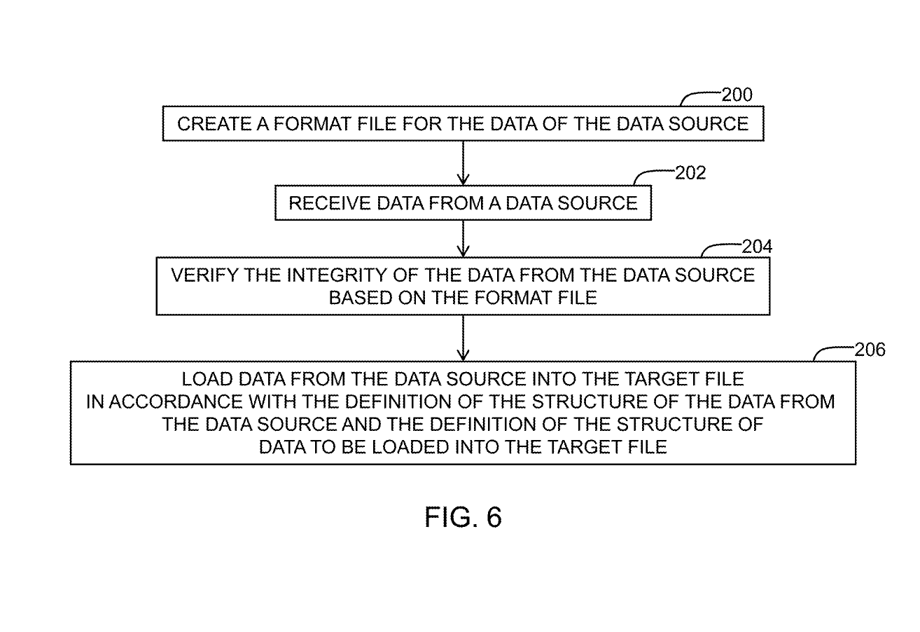

FIG. 6 illustrates a method in accordance with an example. The method includes at 200, creating a format file 182 for data from each data source 150. The format file 182 includes a definition of a structure of the data from each such data source. At 202, the method further includes receiving data from a particular data source 150. The data from the data source may be included in a file that is delivered (e.g., emailed, downloaded, etc.) to or streamed by the data reception module 136. At 204, the method includes verifying integrity of the data from the data source based on the data source data format definition in that data source's format file 182. Examples of integrity verifications are provided above. At 206, the method also includes loading the data from the data source 150 into the target file 140 in accordance with the definition of the structure of the data from the data source (e.g., the data source data format definition in the format file 182) and a definition of a structure of data to be loaded into the target file (e.g., the target file data format definition 184). Loading the table may include changing the order of the data fields between the source data 150 and the target file 140 and/or converting at least some of the data (e.g., converting date formats).

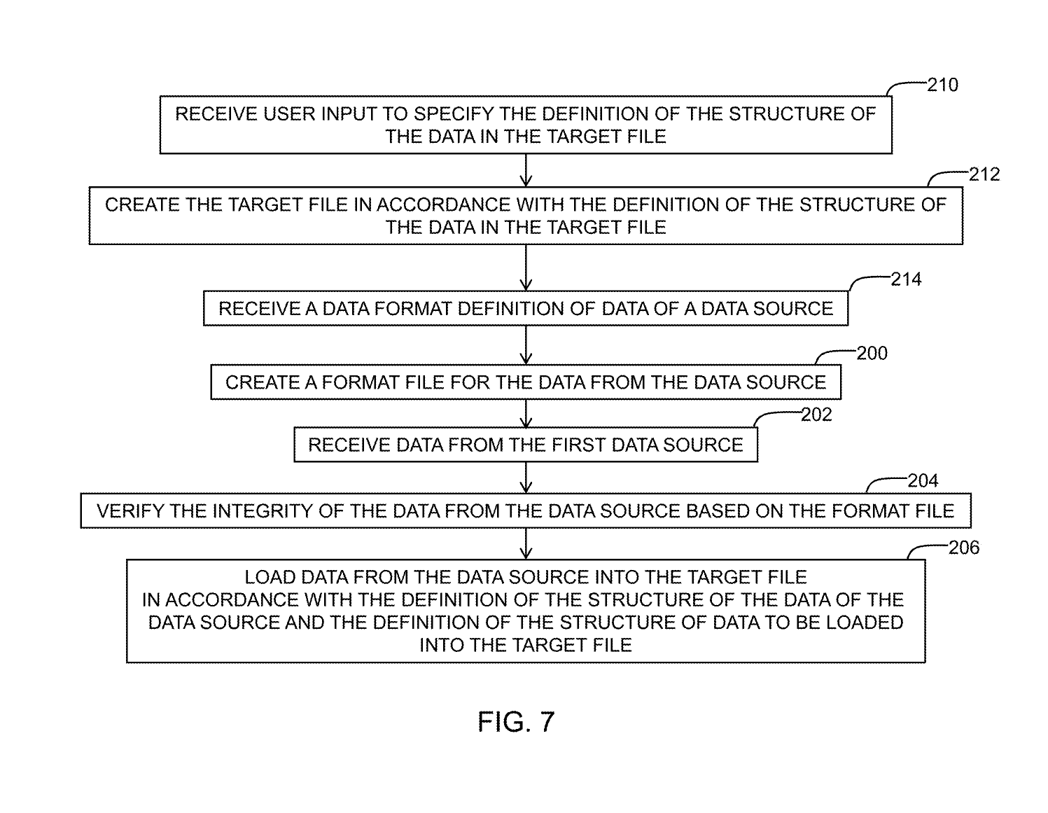

FIG. 7 shows another example of a method. The illustrative method of FIG. 7 also includes operations 200-206 and thus their explanation is not repeated. Operation 210 includes receiving user-input to specify the definition of the structure of the data in the target file 140, and operation 212 includes creating the target file 140 in accordance with the definition so specified. The file is stored on the non-transitory storage device (e.g., storage device 130, 180). At 214, the method includes receiving a data source data format definition of data from a particular data source. The input module 132 may be used in this regard. That, the input module 132 may be used to specify both the target file data format definition and the data source data format definition for each data source 150. A user may provide this information or the data source data format definition may be obtained from the data source itself (e.g., as part of a header of an XML file if the data source supplies its data in the form of an XML file).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory storage device containing machine instructions system that, when executed by a processing resource, cause the processing resource to:
receive user-input to specify a target file data format definition to define how data is to be organized in a target file;
create a target file in accordance with the target file data format definition;
receive a data source data format definition of data of a first data source; and
load data from the first data source into the target file in accordance with the data source data format definition and the target file data format definition.

2. The non-transitory storage device of claim 1 wherein the instructions, when executed, further cause the processing resource to verify integrity of the data from the first data source before the data is loaded into the target file.

3. The non-transitory storage device of claim 2 wherein integrity verification includes at least one of a verification that proper delimiters are used in the data from the first data source, verification of the format of a date in the first data source, and a verification that the number of fields in each record of the data from the first data source is consistent.

4. The non-transitory storage device of claim 1 wherein the instructions, when executed, further cause the processing resource to convert data from the first data source based on the data source data format definition and the target file data format definition.

5. The non-transitory storage device of claim 4 wherein the data to be converted by the processor includes a date that is to be converted from one date format to a different date format.

6. The non-transitory storage device of claim 1 wherein the instructions, when executed, further cause the processing resource to:
receive another data source data format definition of data from a second data source, such other data source data format definition being different than the data source data format definition of the data from the first data source; and
load data from the second data source into the target file in accordance with the data source data format definition of data from the second data source and the target file format definition.

7. The non-transitory storage device of claim 1 wherein the data source data format definition is to be specified by a user, and wherein the instructions, when executed, further cause the processing resource to create a format file corresponding to the first data source, the format file including the user-specified data source data format definition.

8. A method, comprising;
creating a format file for data from a first data source, said format file to include a definition of a structure of the data from the first data source;
receiving data from a first data source;
verifying integrity of the data from the first data source based on the definition in the format file; and
loading the data from the first data source into a target file in accordance with the definition of the structure of the data from the first data source and a definition of a structure of data to be loaded into the target file.

9. The method of claim 8, further comprising:
receiving user-input to specify the definition of the structure of the data in the target file; and
creating the target file in accordance with the definition of the structure of the data in the target file.

10. The method of claim 8 further comprising: before loading the data, converting at least some data from the first data source to a different format based on the definition of the structure of the data in the first data source and based on the definition of the structure of the data in the target file.

11. The method of claim 8 wherein the data from the first data source includes a plurality of records, each record including a plurality of fields of information, and wherein loading the data includes, for each record, changing an order of at least some of the fields from their order in the first data source to a different order in the target file.

12. A system, comprising:
a target file into which data from a plurality of data sources is to be loaded, the target file having a target file format for the data to be loaded therein, and each data source includes data of a format different from each other and different from the target file format;
a format file generation engine to create, for each data source, a format file that is to include a data source data format definition specifying a structure of data from each such data source;
a verification engine to verify that the data from each data source is consistent with the data format definition included in the format file for each such data source;
a data conversion engine to convert at least some data from at least one data source from one format to another format; and
a data load engine to load data from each data source, after verification and data conversion, to the target file based on the data source data format definition from the format file for each such data source and a target file data format definition;
wherein the target file data format definition specifies a structure of data to be loaded into the target file.

13. The system of claim 12 wherein the verification engine is to perform a verification that includes at least one of a verification that proper delimiters are used in the data from each data source, verification of the format of a date in the data from each data source, and a verification that the number of fields in each record of the data from each data source is consistent.

14. The system of claim 12 wherein the verification engine is to verify records in the data from each data source, and the system further includes an error file to identify records that cannot be successfully verified by the verification engine.

15. The system of claim 12 wherein the data conversion engine is to convert a date from one date format to a different date format.
